(19) United States
(12) Patent Application Publication
(10) Pub. No.: US 2012/0119955 A1
(43) Pub. Date: May 17, 2012

(54) ADJUSTABLE MULTIBAND ANTENNA AND METHODS

(76) Inventors: Zlatoljub Milosavljevic, Espoo (FI); Heikki Korva, Tupos (FI)

(21) Appl. No.: 12/919,208

(22) PCT Filed: Feb. 18, 2008
(86) PCT No.: PCT/FI09/50133

§ 371 Date: Jan. 26, 2012

(51) Int. Cl. H01Q 5/01

(52) U.S. Cl. 343/702; 343/700 MS; 343/745

(57) ABSTRACT

An adjustable multiband antenna especially intended to mobile terminals. The antenna structure comprises a radiator (320), a feed element (330) and an adjusting circuit (350). The radiator is a conductive part of the outer cover (COV) of a radio device or conductive coating of the cover. It is fed electromagnetically by a feed element which is isolated from the radiator by a relatively thin dielectric substrate. The feed element is connected either directly or through an intermediate element (340) to the antenna port of the device and to the ground plane (310), and it is shaped so that the antenna has at least two operating bands. The adjusting circuit is connected to an adjusting point (AP) in the feed element, and the reactance between the adjusting point and ground and thus the electric size of the antenna can be changed by means of a switch (SW) in the adjusting circuit. Among other things, the component values of the adjusting circuit and the distance between the short-circuit (SP) and adjusting (AP) points in the feed element are variables from the point of view of the antenna adjustment. Displacements, which have desired directions and lengths, are obtained for at least two operation bands of the antenna independently from each other by changing the switch state. The efficiency of the antenna is better than of the corresponding known antennas, and its matching can be made good both in lower and upper operating band of the antenna.

The invention relates to an adjustable multiband antenna especially intended to mobile terminals.

The adjustability of an antenna means in this description that a resonance frequency or frequencies of the antenna can be changed electrically. The aim is that the operating band of the antenna around a resonance frequency always covers the frequency range, which the operation presumes at each time. There are different causes for the need for adjustability. As portable radio devices, like mobile terminals, are becoming smaller also thickness-wise, the distance between the radiating plane and the ground plane of an internal planar antenna unavoidably becomes shorter. This results in e.g. that the antenna bandwidths will decrease. Then, as a mobile terminal is intended for operating in a plurality of radio systems having frequency ranges relatively close to each other, it becomes more difficult or impossible to cover frequency ranges used by more than one radio system. Such a system pair is for instance GSM1800 and GSM1900 (Global System for Mobile telecommunications). Correspondingly, securing the function that conforms to specifications in both transmitting and receiving bands of a single system can become more difficult. If the system uses sub-band division, it is advantageous if the resonance frequency of the antenna can be tuned in a sub-band being used at each time, from the point of view of the radio connection quality.

In the invention described here the antenna adjustment is implemented by a switch. The use of switches for the purpose in question is well known as such. For example the publication EP1113 524 discloses an antenna, where a planar radiator can at a certain point be connected to the ground by a switch. When the switch is closed, the electric length of the radiator is decreased, in which case the antenna resonance frequency becomes higher and the operating band corresponding to the resonance frequency is displaced upwards. A capacitor can be in series with the switch to set the band displacement as long as desired. The solution is suitable for single-band antennas. The controlled displacement of the operating bands of a multi-band antenna is impossible.

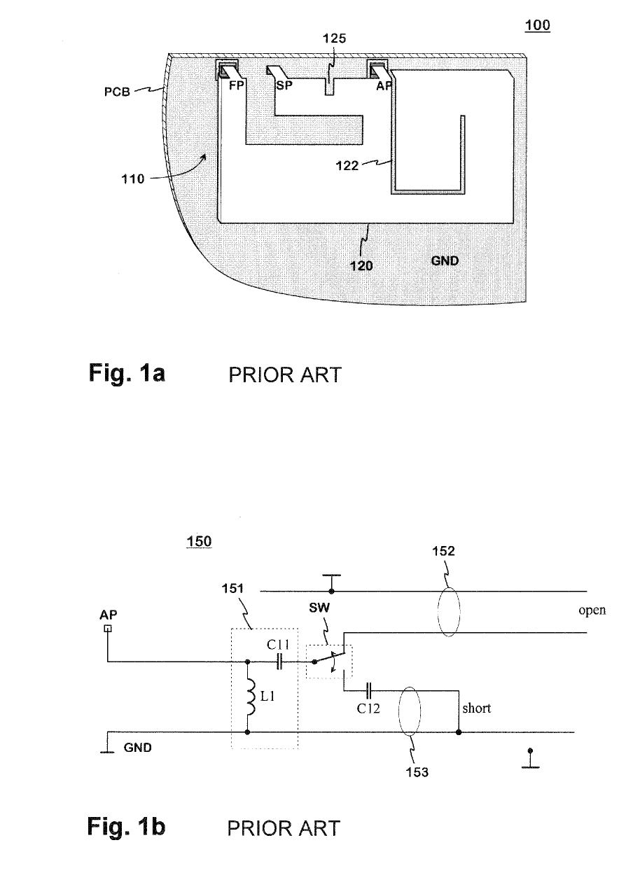

In FIGS. 1a and 1b there is an antenna to be adjusted by a switch, known from the publication WO 2007/012697. In FIG. 1a the antenna 100 is seen from above, or from the side of the radiating plane, and in FIG. 1b there is its adjusting circuit 150. The antenna is of PIFA type (Planar Inverted F-antenna), in which case it comprises the ground plane 110 and the radiating plane 120 with its feed and short-circuit conductors. The ground plane is a part of the signal ground GND on the upper surface of the circuit board PCB of a radio device. The feed conductor joins the radiating plane at the feed point FP and the short-circuit conductor at the short-circuit point. In addition, a conductor of the antenna adjusting circuit joins galvanically the radiating plane at the adjusting point AP. All three points are located at the same long side of the radiating plane, the short-circuit point being therebetween. The radiating plane 120 is shaped so that the antenna is a dual-band antenna; it has a lower and an upper operating band. The lower operating band is based on the resonator constituted by the whole radiating plane and the ground plane, and the upper operating band is based on the slot radiator, the slot of which 122 starts at the edge of the radiating plane, beside the adjusting point AR An L-shaped slot starts between the feed and short-circuit points, by which the antenna matching is improved both in the lower and the upper operating bands.

Based on the location of the adjusting point AP, a circuit connected to it affects both the lower and the upper operating band. If the adjusting point were connected directly to the ground plane, for example, the electric length of both the antenna part corresponding to the lower operating band and the part corresponding to the upper operating band would decrease, in which case both bands would be displaced upwards. In the structure shown in FIGS. 1a, b, the directions and lengths of the displacements of the bands are set to be desired by means of the design of the adjusting circuit and by choosing the electric distance between the short-circuit point SP and the adjusting point AP. This distance is naturally affected by the direct distance between the points SP and AP. In the example of FIG. 1a the electric distance is tuned by a notch 125 in the portion of the radiating plane between those points.

The adjusting circuit 150 comprises, in order from the radiator, an input line, an LC circuit 151, a switch SW and the tuning lines 152, 153. The LC circuit 432 is on one hand for the ESD protection of the switch and on the other hand for increasing the number of the variable parameters of the adjusting circuit. It is formed of a coil L1 and a capacitor C11. The coil has been connected transversely to the input line, and the capacitor C11 is in series with the conductor of the input line, which conductor has been separated from the ground. The switch is a two-way switch, the common terminal of which, or input, can be connected to one of two other terminals. These other terminals are called outputs of the switch. The first output of the switch is connected to the head end of the separate conductor of the first tuning line 152, and the second output is connected, through a capacitor C12, to the head end of the separate conductor of the second tuning line 153. Thus the input line of the adjusting circuit can continue, after the LC circuit and the switch, either as the first tuning line or as the second tuning line. When the switch state is changed, the reactive impedance, which is “seen” from the adjusting point AP of the radiating plane to the ground, changes, in which case the resonance frequencies of the antenna parts change and the operating bands therefore are displaced.

In the example of FIG. 1b the first tuning line 152 is open at its tail end and the second tuning line 153 is short-circuited at its tail end. The tuning lines are short, usually shorter than a quarter wavelength. In that case the open line represents a certain capacitance, and the short-circuited line represents a certain inductance. As known, the values of the capacitance and the inductance depend on the frequency: At the frequencies of the upper operating band they are higher than at the frequencies of the lower operating band, if the line is shorter than the quarter wavelength also in the upper band. So the lengths of the tuning lines are used as variables when the adjusting circuit is designed. Among other things, the values of the discrete components of the adjusting circuit and the above-mentioned electric distance between the short-circuit point SP and the adjusting point AP of the radiating plane are other variable parameters. The number of the variables and their different frequency characteristics make it possible to design the antenna with its adjusting circuit so that the displacements having desired directions and lengths can be obtained for the lower and upper operating bands independently from each other.

A disadvantage of the above-described solution is that the PIFA presumed by it is not satisfactory to use for its space requirements, when a radio device has to be particularly small and flat.

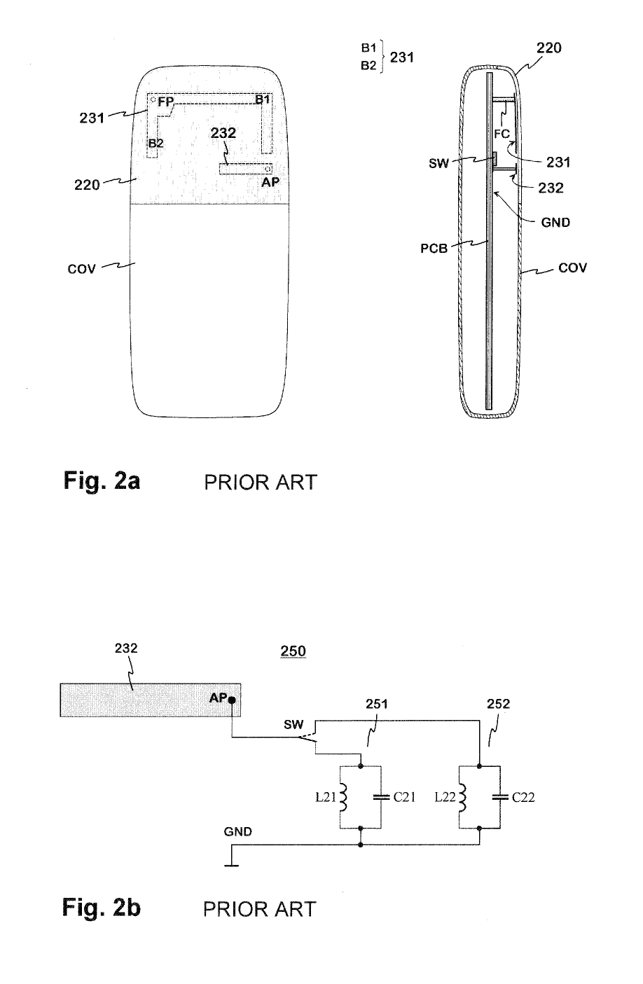

In FIGS. 2a and 2b there is an antenna to be adjusted by a switch, known from the patent application FI 20065728. In FIG. 2a it is seen, both from behind and from the side as a simplified longitudinal section, a radio device, the antenna of which is in question, and in FIG. 2b there is the adjusting circuit 250 of the antenna. The upper part of the rear part of the outer cover COV of the device, which upper part is of conductive material, functions now as the radiator 220 of the antenna. At the radiator on the circuit board PCB of the radio device there is signal ground GND, which functions as the ground plane of the antenna. The radiator is electromagnetically fed by a separate feed element 231, which is a conductor strip on the surface of a thin and flexible dielectric substrate. One side of the substrate is against the inner surface of the radiator. The feed element 231 is presented as a dotted line in the rear view of the radio device and as a line following the outer cover in the section drawing. The feed element resembles a wide rectangular letter U in this example. Its middle portion is relatively close to the end of the radio device to which the radiator 220 extends, and the parallel side portions are directed from the ends of the middle portion towards the opposite end of the device. The feed point FP of the antenna is in one corner point of the feed element from which it is coupled to the antenna port on the circuit board PCB of the radio device by a feed conductor FC. Because of its location, the feed point FP divides the feed element 231 into two branches of different lengths. The first and longer branch B1 together with the antenna's other parts resonates in the lower operating band of the antenna, and the second and shorter branch B2 together with the antenna's other parts resonates in the upper operating band. The feed element can also be short-circuited to the ground.

On the surface of said substrate there is, in addition to the feed element 231, a parasitic element 232. This is a conductor strip parallel to the middle portion of the feed element being located, seen from the feed point FP, relatively close to the diagonally opposite corner of the radiator. At one end of the parasitic element there is the adjusting point AP of the antenna, from which the parasitic element can be connected to the ground GND through alternative reactive circuits. The parasitic element 232, a two-way switch SW to be used for the connection and the reactive circuits 251, 252 constitute the adjusting circuit 250 of the antenna. The reactive circuits are parallel resonance circuits: The first reactive circuit 251 consists of the parallel circuit of a coil L21 and a capacitor C21 and the second reactive circuit 252 of the parallel circuit of a second coil L22 and a second capacitor C22.

The adjusting circuit is designed as follows: When the first reactive circuit 251 is selected by the switch, the impedance of the adjusting circuit is capacitive in the lower operating band and inductive in the upper operating band. When the second reactive circuit 252 is selected, the impedance of the adjusting circuit is inductive in the lower operating band and capacitive in the upper operating band. Regarding the lower operating band, the impedance then changes from capacitive to inductive and regarding the upper operating band from inductive to capacitive, when the first reactive circuit is changed to the second reactive circuit. This results in that the electric length of the whole antenna increases in the lower operating band and decreases in the upper operating band. This further means that the lower operating band is displaced downwards and the upper operating band upwards. With one state of the switch the antenna can function for example in the GSM850 and GSM1800 systems and with the other state of the switch in the EGSM- (Extended GSM) and GSM1900 systems.

The antenna according to FIG. 2a is space-saving, because the outer cover of the radio device is used as the radiator and the distance between the ground plane and the feed element can be smaller than the distance between the ground plane and the radiator in an ordinary PIFA. In addition, the radiator can be shaped relatively freely and it can be also large, because the electric matching of the antenna can be implemented mostly by means of the shaping of the feed element and parasitic element. A disadvantage in the solution according to FIGS. 2a, b is that the efficiency of the antenna remains modest because of the relatively high switch losses. In addition, an area has to be reserved for the parasitic element on the substrate below the radiator, which restricts the optimal shaping of the feed element.

The object of the invention is to implement the adjustment of a multiband antenna in a new way, which alleviates the flaws associated with the prior art. An adjustable multiband antenna according to the invention is characterized in that which is specified in the independent claim 1. Some advantageous embodiments of the invention are presented in the dependent claims.

The basic idea of the invention is as follows: The antenna structure comprises a radiator, a feed element and an adjusting circuit. The radiator is a conductive part of the outer cover of a radio device or conductive coating of the cover. It is fed electromagnetically by a feed element which is isolated from the radiator by a relatively thin dielectric substrate. The feed element is connected either directly or through an intermediate element to the antenna port of the device and to the ground plane, and it is shaped so that the antenna has at least two operating bands. The adjusting circuit is connected to an adjusting point in the feed element, and the reactance between the adjusting point and ground and thus the electric size of the antenna can be changed by means of a switch in the adjusting circuit. Among other things, the component values of the adjusting circuit and the distance between the short-circuit and adjusting points in the feed element are variables from the point of view of the antenna adjustment.

An advantage of the invention is that displacements, which have desired directions and lengths, are obtained for at least two operation bands of the antenna independently from each other by changing the switch state. This is due to the amount and nature of the variables to be used in the design. Another advantage of the invention is that the displacements of the operating bands can be implemented by a relatively simple and space-saving adjusting circuit. A further advantage of the invention is that the efficiency of the antenna is better than of the corresponding known antennas. This is due to that the currents in the switch can be kept relatively low by means of the internal impedance arrangements of the antenna structure. A further advantage of the invention is that, the radiating element being in the cover of the device, the space required for the antenna inside the device is relatively small and the radiation characteristics of the antenna are improved compared to an inner-located radiator. A further advantage of the invention is that it makes possible a good matching both in lower and upper operating band of the antenna. A further advantage of the invention is that both arranging the locations of the operating bands and matching of the antenna can be implemented without shaping the radiator element because of them.

Below the invention is described in detail. Reference will be made to the accompanying drawings where

FIGS. 1a,b present an example of the adjustable antenna according to the prior art,

FIGS. 2a,b present a second example of the adjustable antenna according to the prior art,

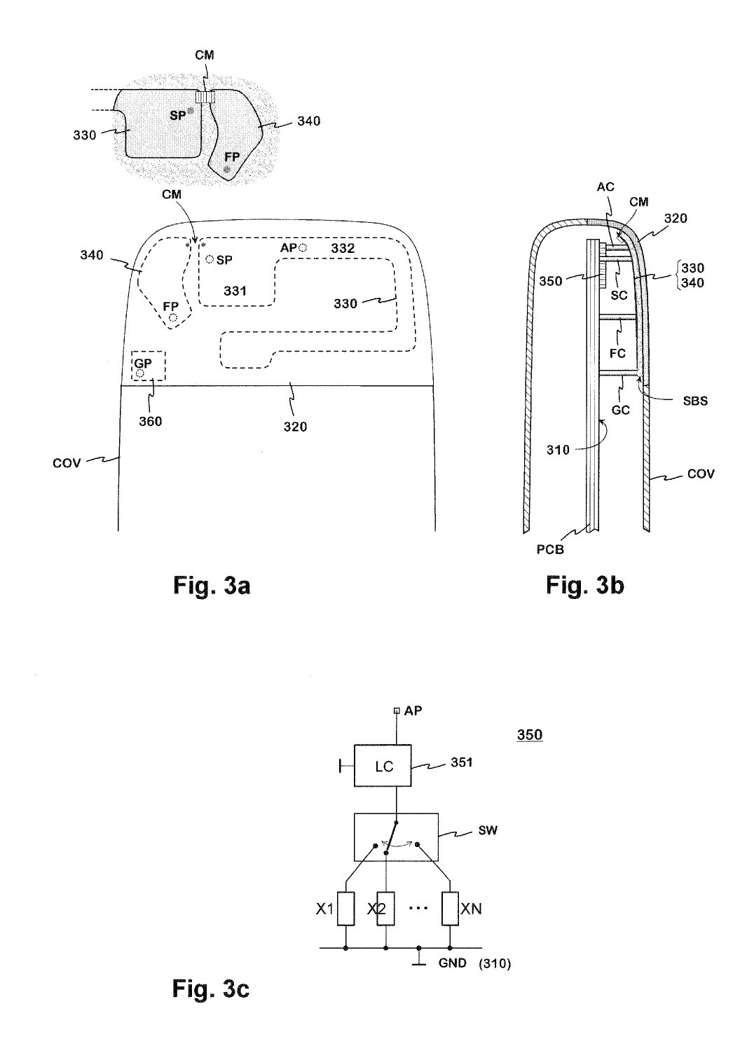

FIGS. 3a-c present an example of the adjustable antenna according to the invention,

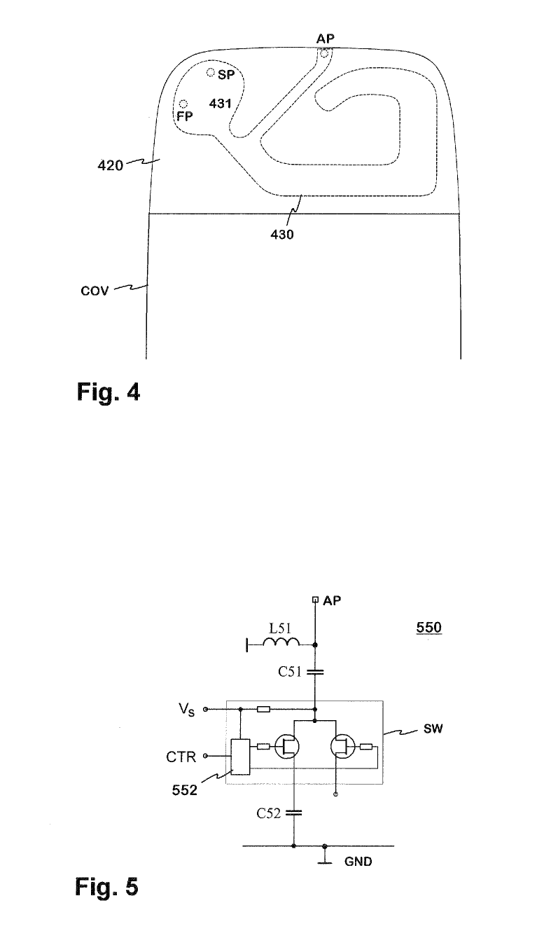

FIG. 4 presents a second example of the adjustable antenna according to the invention,

FIG. 5 presents an example of the adjusting circuit of an antenna according to the invention,

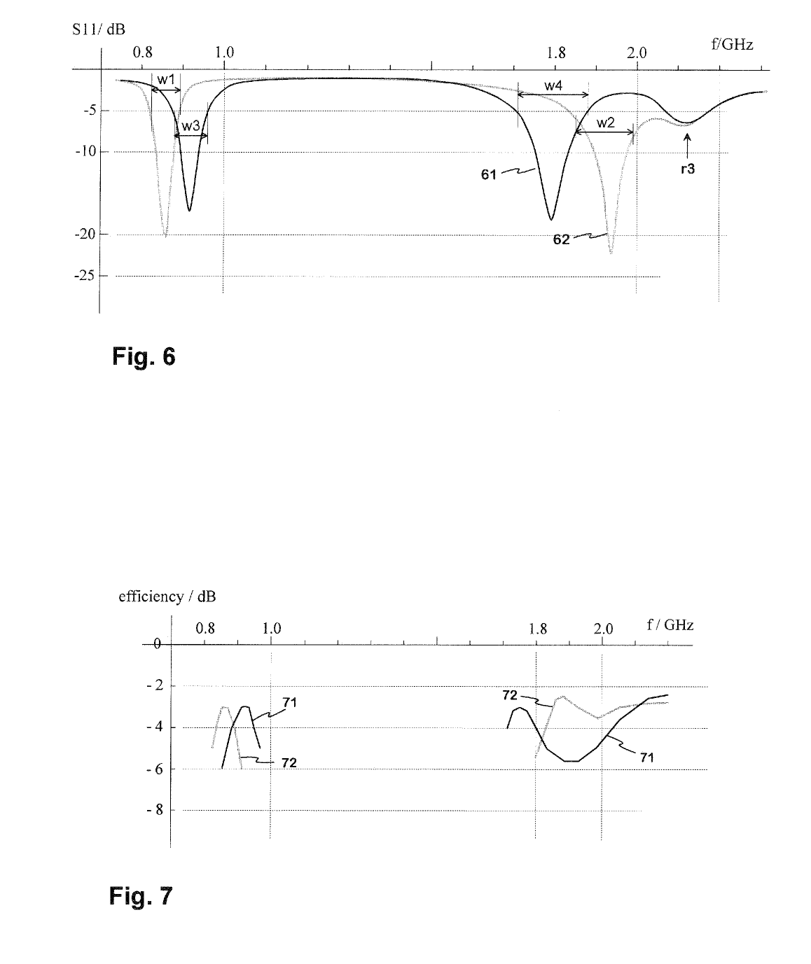

FIG. 6 presents an example of the displacement of the operation bands of an antenna according to the invention, and

FIG. 7 presents an example of the efficiency of an antenna according to the invention.

FIGS. 1 and 2 were already described in conjunction with the description of the prior art.

In FIGS. 3a, 3b and 3c there is an example of the antenna according to the invention to be adjusted by a switch. A radio device including the antenna is shown in FIG. 3a from behind, in FIG. 3b from the side as a simplified longitudinal section, and in FIG. 3c there is the principled structure of the adjusting circuit of the antenna. The antenna comprises a ground plane 310, which is a part of the signal ground GND, a radiating element, or radiator 320, which is a conductive part of the outer cover COV of the radio device, its feed element 330 and the adjusting circuit 350, as in FIG. 2a. The radiator forms one head of the rear part of the cover COV. Below the transverse direction means the direction of the head and the longitudinal direction correspondingly the direction of the long side of the cover COV perpendicular to the transverse direction. The feed element 330 is a conductor strip on the inner surface of a thin and flexible dielectric substrate SBS, the outer surface of which is against the inner surface of the radiator. The feed element is connected to the ground plane from a short-circuit point SP close to its first end. The feed element comprises, starting from the short-circuit point, first a relatively broad first portion 331, which turns into a narrower second portion 332. This extends in the transverse direction near to a side edge of the radiator. There the second portion 332 is succeeded by a longitudinal third portion and finally a fourth portion, which turns back towards the opposite, or second, side edge of the radiator extending in the transverse direction over the midway of the radiator.

On the inner surface of the substrate SBS there is in this example also an inter mediate element 340, which is located mostly between the first portion 331 of the feed element and the second side edge of the radiator. In this example the feed point FP of the antenna is located in the intermediate element 340, at its farther end viewed from the head in question. The feed point FP is connected to the antenna port of the radio device on its circuit board PCB by the feed conductor FC visible in FIG. 3b. Correspondingly, the short-circuit point SP in the feed element is connected to the ground plane 310 on the circuit board by the short-circuit conductor SC.

The intermediate element 340 and the first portion 331 of the feed element are so close to each other that there is a sufficient electromagnetic coupling between them for transferring transmitting energy to the field of the feed element and further to the field of the radiator 320. On the other hand, the intermediate element also feeds directly the radiator. Thus the intermediate element 340 and the feed element 330 together constitute a functional total feed element. By means of the separate intermediate element the chance to achieve a good matching simultaneously both in the lower and upper operating band is enhanced. For this end the above-mentioned electromagnetic coupling is tuned to be suitable by a capacitor CM, which is connected between the intermediate element and the first portion of the feed element relatively near to said short-circuit point SP. The short-circuit point again, agreeing with this matter, is preferably located near to the edge of the first portion 331 on the side of the intermediate element. The capacitor CM is visible in the small supplementary figure of FIG. 3a, in which the intermediate element and the first portion of the feed element are drawn as seen from the inside of the device.

The upper operating band of the antenna is based on the resonance of the intermediate element together with the first portion of the feed element, the radiator and the ground plane. The lower operating band of the antenna is based on the resonance of the whole feed element together with the other antenna parts.

The adjusting circuit 350 is connected to the feed element 330 in the antenna according to the invention. The connection point of the adjusting circuit, or the adjusting point AP, is in the second portion 332 of the feed element. For the sake of the location of the adjusting point AP the adjusting circuit affects both the lower and upper operating band. The directions and lengths of the displacements of the bands are set to the ones desired by means of the design of the adjusting circuit and by choosing the electric distance between the short-circuit point SP and the adjusting point AP. This distance is then an important parameter when designing the antenna. If the electric distance increases from a certain value, the displacements of the operating bands increase when the state of the switch in the adjusting circuit is changed.

The adjusting circuit 350 is located on the circuit board PCB and is connected to the adjusting point AP by a conductor AC. The adjusting circuit as such is similar to the one in FIG. 1, in principle. It comprises, in order from the feed element, an LC circuit 351, a multi-way switch SW and reactive circuits X1 to XN. The LC circuit is on one hand for the ESD protection of the switch and on the other hand for increasing the number of the variable parameters of the adjusting circuit. In addition, it can function as a filter, the cut-off frequency of which is between the lower and upper operating band of the antenna. When the aim is to displace only the upper operating band, the filter is of the high-pass type, and when the aim is to displace only the lower operating band, the filter is of the low-pass type. By means of the switch it is selected, which one of the reactive circuits will be connected in series with the LC circuit, between it and the ground GND. The index N before means that the number of the alternative reactive circuits can vary. Correspondingly, the number of the alternative locations of at least one operating band can vary. A single reactive circuit can comprise one capacitor or coil, a combination of one or more capacitor(s) and one or more coil(s), or it can be based on a short, open or short-circuited, transmission line as in FIG. 1b. In a special case the length of such a transmission line is practically zero.

In the example of FIGS. 3a, b there is also a relatively small tuning element 360 on the inner surface of the substrate SBS. It is located in the corner formed by the second side edge of the radiator and the edge facing the middle part of the device, and is connected to the ground plane from one of its points by a ground conductor GC. The object of the tuning element 360 is to set a certain harmonic frequency of the basic frequency of the resonance appearing in the antenna structure to a desired point on the frequency scale, which resonance is mainly based on the radiating element and ground plane. A separate third operating band can be constituted or said upper operating band can be widened by that harmonic frequency.

In FIG. 4 there is a second example of the antenna according to the invention to be adjusted by a switch. A radio device including the antenna is shown from behind in the figure. The radiator 420 is a conductive part of the outer cover COV of the radio device, and for it there is a feed element 430 isolated by a thin substrate, as in FIG. 3a. Further also in this example the adjusting circuit, being not visible, is connected to the feed element at a point AP. A substantial difference to the structure shown in FIGS. 3a, b is that there is no intermediate element, but the feed point FP of the antenna is located in the feed element relatively close to its short-circuit point SP. The feed element is shaped so that the lower operating band of the antenna is based on the resonance, which the whole feed element has together with the other antenna parts, and the upper operating band is based on the resonance, which the end 431 of the feed element on the side of the feed and short-circuit points has together with the radiator and ground plane. The adjusting point AP is located at the end of a strip branching from the rest of the feed element, by which shaping the electric distance between the short-circuit point SP and the adjusting point AP is affected.

FIG. 5 shows an example of the adjusting circuit of an antenna according to the invention. The LC circuit of the adjusting circuit 550 is similar to the one in FIG. 1b. Thus it comprises a coil L51 transversely in the input line of the adjusting circuit and a capacitor C51 in series with the conductor of the input line separated from the ground. By means of the LC circuit in this case the number of the variable parameters of the adjusting circuit is increased, the switch is protected for the ESD and the forming of a direct current circuit from the switch SW to the ground through the coil L51 and the feed element is prevented. The inductance of the coil is e.g. 6 nH and the capacitance of the capacitor C51 8 pF. In this example the multi-way switch SW is implemented by the field effect transistors, which are e.g. of PHEMT type (Pseudomorphic High Electron Mobility Transistor). The number of the transistors is two so that the switch has two outputs. Which transistor is conductive, depends on the state of the control signal CTR. The integrated switch contains a control circuit 552, the input signal of which the control signal CTR is, and which sets the gate voltages of the transistors. Also a supply voltage Vₛ is naturally needed in the switch. The first output of the switch is connected to the ground through a capacitor C52. The capacitance of this is e.g. 100 pF, which corresponds to a short-circuit at the use frequencies of the antenna. Therefore, the aim of the capacitor C52 is to prevent the forming of a direct current circuit from the switch to the ground.

Also a considerably lower capacitance value, representing a certain reactance, can be used. The second output of the switch is open so that the impedance between it and the ground is very high.

The adjusting circuit is designed so that the whole adjusting circuit is “seen” as a short-circuited transmission line with the length of about the quarter wave at the frequencies of the lower operating band and correspondingly as a short-circuited transmission line with the length about of the half wave at the frequencies of the upper operating band, when the feed element is connected to the short-circuited output of the switch. Secondly, when the feed element is connected to the open output of the switch, the whole adjusting circuit would be “seen” as an open transmission line with the length about of the quarter wave at the frequencies of the lower operating band and correspondingly as an open transmission line with the length about of the half wave at the frequencies of the upper operating band. In this case the impedance of the adjusting circuit would change from low to high in the lower operating band and from high to low in the upper operating band, when the state of the switch is changed. This again results in that the lower operating band is displaced downwards and the upper operating band upwards or vice versa.

FIG. 6 shows an example of the displacements of the operation bands of an antenna according to the invention. The example relates to an antenna with an adjusting circuit like the one in FIG. 5. The object has been that in one switch state the antenna's lower operating band would cover the frequency range 890-960 MHz, w1 in the figure, of the GSM900 system and the upper operating band would cover the frequency range 1710-1880 MHz, w2 in the figure, of the GSM1800 system. In the other switch state the lower operating band would cover the frequency range 824-894 MHz, w3 in the figure, of the GSM850 system and the upper operating band would cover the frequency range 1850-1990 MHz, w4 in the figure, of the GSM1900 system. Curve 61 shows the fluctuation of the reflection coefficient as a function of frequency, when the radiator is connected to the short-circuited output of the switch, and curve 62 shows the fluctuation of the reflection coefficient, when the radiator is connected to the open output of the switch. From the curves it can be found that the above-mentioned object is fulfilled if the value −5 dB is considered as a criterion for the usable reflection coefficient.

From the curves 61 and 62 it can also be found that the antenna has a third resonance r3 above the frequency 2.1 GHz. It is the case the resonance mainly of the radiating element and the ground plane, which resonance is tuned by the element 360 visible in FIG. 3a. Because of the resonance r3 the antenna has a third operating band, which is intended for the receiving band 2110-2170 MHz of the WCDMA system (Wideband Code Division Multiple Access).

By changing the antenna design, the location of the lower operating band can be set also e.g. either at the transmitting or receiving band of the GSM900 system. Similarly can be implemented a sub-band division both in the transmitting and receiving band by means of a multi-way switch (SPnT, single-pole n through).

FIG. 7 shows an example of the efficiency of an antenna according to the invention. The example concerns the same structure as the matching curves in FIG. 6. Curve 71 shows the fluctuation of the efficiency as a function of frequency in free space, when the radiator is connected to the short-circuited output of the switch, and curve 72 shows fluctuation of the efficiency in free space, when the radiator is connected to the open output of the switch. It can be seen from the curves that in the lower operating bands w1 and w3 the efficiency is −5 dB or better, and in the upper operating bands −3.5 dB or better in the band w2 and −5.5 dB or better in the band w4.

The adjustable multiband antenna according to the invention has been described above. Its structure can in details vary from that presented. For example the radiator of the antenna can be, instead of a conductive part of the cover, conductive coating of a dielectric cover. The multi-way switch used in the adjusting circuit can also be made e.g. by the MEMS (Micro Electro Mechanical System) technique. The ground plane of the antenna can be below the whole radiator or only below a part of the radiator. The invention does not limit the manufacturing method of the antenna. The inventive idea can be applied in different ways within the scope defined by the independent claim 1.

1.-8. (canceled)

9. A multiband antenna for use in a radio device capable of operating in at least a first frequency band and a second frequency band, said antenna comprising:
a feed element, comprising:
a feed point coupled to a feed port of the radio device;
a short-circuit point coupled to a ground plane; and
an adjusting point;
a radiating element comprising a conductive portion capable of being disposed on a cover of the radio device;
an adjusting circuit coupled to the adjusting point and configured to effect a predetermined frequency shift in at least one of the first and second operating frequency bands, the adjusting circuit comprising:
a multi-way switch; and
at least two reactive circuits coupled to the ground plane and being selectable by the switch;
wherein the conductive portion is isolated from the feed element by a dielectric substrate thereby effecting electromagnetic coupling between the radiating element and the feed element;
wherein the feed element is shaped so as to at least partly induce a resonance in the first or second operating frequency bands during operation; and
wherein an electric length between the adjusting point and the short-circuit point is based at least in part on the predetermined frequency shift.

10. A planar antenna assembly operable in at least a first frequency band and a second frequency band, the assembly comprising:
a dielectric substrate comprising a first surface;
a feed element, disposed at least partly on the first surface and comprising:
a feed point, configured to couple to a feed port;
a short-circuit point configured to couple to a ground plane; and
an adjusting point; and
a radiating element;
wherein the adjusting point is disposed within the feed element.

11. The antenna assembly of claim 10, wherein the dielectric substrate is configured to isolate the conductive portion from the feed element, thereby effecting electromagnetic coupling between the radiating element and the feed element

12. The antenna assembly of claim 10, further comprising an adjusting circuit, the adjusting circuit comprising:
at least two reactive circuits configured to couple to the ground plane; and
a multi-way switch configured to selectively couple one of the at least two reactive circuits to the adjusting point.

13. The antenna assembly of claim 12, wherein the adjusting circuit further comprises an inductive and capacitive (LC) circuit disposed between the adjusting point and the multi-way switch.

14. The antenna assembly of claim 12, wherein the at least two reactive circuits comprise a shorted circuit and an open circuit configured for operating at a frequency within said at least first and second frequency bands.

15. The antenna assembly of claim 10, wherein an electric path length between the adjusting point and the short-circuit point is selected so as to cause a predetermined frequency shift of at least one of said first frequency band and said second frequency band.

16. The antenna assembly of claim 10, further comprising an intermediate element configured to receive the feed point, the intermediate element comprising a coupling element configured to electromagnetically couple the feed element to the radiating element;

17. The antenna assembly of claim 16, wherein the short-circuit point is located proximate an edge of the feed element; and
wherein the coupling element is disposed proximate the short circuit point.

18. The antenna assembly of claim 16, wherein the coupling element comprises a capacitor coupled between the intermediate element and the feed element, the capacitor configured for tuning antenna matching in both the first frequency band and the second frequency band.

19. The antenna assembly of claim 18, wherein:
when the feed element is connected to the shorted circuit, the adjusting circuit comprises:
a quarter-wavelength short-circuited transmission line at a frequency within the first frequency band; and
a half-wavelength short-circuited transmission line at a frequency within the second frequency band, and
when the feed element is connected to the open circuit, the adjusting circuit comprises:
a quarter-wavelength open transmission line at a frequency within the first frequency band; and
a half-wavelength open transmission line at a frequency within the second frequency band.

20. The antenna assembly of claim 19, wherein the adjusting circuit is configured to displace the first and the second frequency bands in opposite directions responsive to a state change of the multi-way switch.

21. The antenna assembly of claim 10, further comprising a tuning element disposed on the first surface and configured to operate at a first resonance frequency.

22. The antenna assembly of claim 12, wherein the multi-way switch is selected from the group consisting of:
a field-effect transistor (FET) switch;
a pseudomorphic high electron mobility transistor (PHEMT) switch; and
microelectromechanical system (MEMS) switch.

23. The antenna assembly of claim 10, wherein the radiator comprises an electrically conductive coating portion capable of being disposed on the cover of a radio device.

24. The antenna assembly of claim 12, wherein the radiating element comprises an electrically conductive coating portion capable of being disposed on a cover of a radio device.

25. The antenna assembly of claim 24, further comprising a tuning element capable of being disposed on the first surface and configured to operate at a first resonance frequency.

26. The antenna assembly claim 25, wherein the adjusting circuit further comprises an inductive and capacitive (LC) circuit coupled between the adjusting point and a multi-way switch.

27. A portable radio device operable in at least a first frequency band and a second frequency band, the portable radio device comprising:
a cover;
an electronics assembly comprised of a ground plane, control logic, and a transceiver having a feed port; and
a multiband antenna, comprising:
a dielectric substrate comprising a first surface;
a feed element, disposed at least partly on the first surface and comprising:
a feed point coupled to the feed port;
a short-circuit point coupled to the ground plane; and
an adjusting point; and
a radiating element disposed on the cover;
wherein the dielectric substrate is configured to isolate the radiating element from the feed element, thereby effecting electromagnetic coupling between the radiating element and the feed element.

28. The device of claim 27, wherein the multiband antenna further comprises an adjusting circuit coupled to the adjusting point, the adjusting circuit comprising:
at least two reactive circuits coupled to the ground plane; and
a multi-way switch;
wherein the multi-way switch selectively couples one of the at least two reactive circuits to the adjusting point responsive to a signal from the control logic.)

29. The device of claim 28, wherein the at least two reactive circuits comprise a shorted circuit and an open circuit, said shorted circuit and an said open circuit each configured for operating at a frequency within both the first and second frequency bands.

30. The device of claim 29, wherein:
when the feed element is connected to the shorted circuit, the adjusting circuit comprises:
a quarter-wavelength short-circuited transmission line at a frequency within the first frequency band; and
a half-wavelength short-circuited transmission line at a frequency within the second frequency band; and
when the feed element is connected to the open circuit, the adjusting circuit comprises:
a quarter-wavelength open transmission line at a frequency within the first frequency band; and
a half-wavelength open transmission line at a frequency within the second frequency band.

31. An adjustable antenna having at least a lower operating band and an upper operating band and comprising:
a ground plane;
a radiating element;
a feed element capable of being connected to an antenna port of a radio device; and
an adjusting circuit;
wherein the radiating element comprises either: (1) a conductive part of an outer cover of the radio device; or (2) a conductor coating of the cover, and is galvanically isolated from the feed element by a substrate such that there is only an electromagnetic coupling between the radiating element and the feed element.

32. The antenna of claim 31, wherein:
the feed element comprises a short-circuit point connected to the ground plane, the feed element shaped so that it effects, together with other parts of the antenna, a resonance frequency in both the lower and upper operating bands,
the adjusting circuit displaces at least one of the lower and/or upper operating bands of the antenna, and comprises a multi-way switch and at least two alternative reactive circuits connected to the ground plane;
the feed element comprises an adjusting point, the adjusting circuit being electrically disposed between the adjusting point and the ground plane; and
an electric distance in the feed element between the adjusting point and the short-circuit point is arranged to displace the upper operating band by a first predetermined value, and the lower operating band by a second predetermined value.

33. The antenna of claim 31, further comprising an intermediate element having a feed point;
wherein the intermediate element is configured to be electromagnetically coupled to (1) the radiating element; and (2) an edge of the feed element; and
wherein a short-circuit point is located proximate said edge.

34. The antenna of claim 33, further comprising a capacitor disposed between the intermediate element and the feed element, the capacitor configured to enable tuning of the antenna in the lower and the upper operating band.

35. The antenna of claim 32, wherein the adjusting circuit further comprises an inductive and capacitive (LC) circuit coupled between the adjusting point and the multi-way switch, the LC circuit configured to vary at least one parameter of the adjusting circuit.

36. The antenna of claim 31, further comprising at least two reactive circuits consists of two circuits; and
wherein a first of said two reactive circuits comprises a shorted circuit, and a second of said two reactive circuit comprises an open circuit; both said first and second reactive circuits are capable of operating in at least the lower and upper operating band.

37. The antenna of claim 36, wherein:
the adjusting circuit is configured so that it operates, if the feed element is connected to the shorted circuit:
as a short-circuited transmission line with a quarter-wave length at a frequency within the lower operating band; and
as a short-circuited transmission line with a half-wave length at a frequency within the upper operating band; and
the adjusting circuit is further configured so that it operates, if the feed element is connected to said open circuit;
as an open transmission line with a quarter wave length at a frequency within the lower operating band; and
as an open transmission line with a half wave length at a frequency within the upper operating band;
wherein the adjusting circuit is further configured to displace the lower and the upper frequency bands in opposite directions responsive to a state change of the multi-way switch.

38. The antenna of claim 31, further comprising a tuning element disposed on the surface of said substrate, the tuning element configured to adjust a resonance frequency of a resonator constituted by the radiating element and the ground plane.

39. The antenna of claim 31, wherein said multi-way switch is manufactured by a pseudomorphic high electron mobility transistor (PHEMT) technique or microelectromechanical system (MEMS) technique.

40. An adjustable antenna having at least a lower and an upper operating band and comprising a ground plane, a radiating element, a feed element to be connected to an antenna port of a radio device and an adjusting circuit, which radiating element is a conductive part of an outer cover of the radio device or of conductor coating of the cover and is galvanically isolated from the feed element by a substrate, in which case there is only an electromagnetic coupling between the radiating element and the feed element, which feed element comprises a short-circuit point (SP) connected to the ground plane and is shaped so that it has together with other parts of the antenna a resonance frequency both in lower and upper operating band, which adjusting circuit comprises, to displace at least one operating band of the antenna, a multi-way switch (SW) and at least two alternative reactive circuits connected to the ground plane at their one end, characterized in that the feed element comprises an adjusting point (AP), the adjusting circuit then being connected between this adjusting point and the ground plane, and an electric distance in the feed element between the AP and the SP being arranged for displacement of the operating bands with a desired length.
